(19) United States
(12) Patent Application Publication
(10) Pub. No.: US 2008/0268192 A1
(43) Pub. Date: Oct. 30, 2008

(54) TUBULAR BODY

(75) Inventor: Hiroyuki Suzuki, Nishitokyo City (JP)

Correspondence Address: SUGHRUE-265550, 2100 PENNSYLVANIA AVE. NW, WASHINGTON, DC, 20037-3213, US

(73) Assignee: DAIWA SEIKO, INC., Higashikurume-shi (JP)

(21) Appl. No.: 12/107,804

(22) Filed: Apr. 23, 2008

(30) Foreign Application Priority Data
Apr. 27, 2007 (JP) 2007-120036

(51) Int. Cl. B29C 70/10; B29D 23/00

(52) U.S. Cl. 428/36.3

(57) ABSTRACT

A tubular body comprising: a main body layer formed by winding a fiber-reinforced prepreg including reinforcing fibers impregnated with a synthetic resin; and a reinforcing layer wounded around the main body. The reinforcing layer includes: an axial fiber layer including reinforcing fibers aligned in an axial direction of the tubular body; a skew fiber layer formed by aligning a first skew fiber layer formed of reinforcing fibers aligned in a skew direction and a second skew fiber layer formed of reinforcing fibers aligned in a different skew direction; a circumferential fiber layer formed by aligning reinforcing fibers in a circumferential direction of the tubular body. The axial fiber layer, the skew fiber layer and the circumferential fiber are braided with a braiding yarn softer than the reinforcing fibers to form braided prepreg as the reinforcing layer.

### BACKGROUND OF THE INVENTION

The present invention concerns a tubular body and, particularly, it relates to a tubular body formed by winding a fiber-reinforced prepreg having reinforcing fibers impregnated with a synthetic resin.

Generally, a tubular body such as a shaft of a golf club is formed as a laminate prepared by winding a fiber-reinforced prepreg having reinforcing fibers impregnated with a synthetic resin so as to overlap a mandrel, winding a tightening tape thereover for stabilization, then heat setting the synthetic resin in a heating furnace, subsequently, cooling the same, and by way of steps such as removal of the mandrel, peeling of the tightening tape, polishing, and coating.

While the tubular body formed of such a fiber-reinforced prepreg is excellent in specific strength and specific rigidity, the property of the tubular body changes greatly depending on the direction and the lamination conditions of the reinforcing fibers.

In view of the above, taking notice on the fracture of a tubular body such as a golf shaft or a fishing rod attributable to the inter-layer peeling due to elongation of the reinforcing fiber structure, a braided tubular body having stability in the longitudinal shape has been developed in which longitudinal dimension stabilizing yarns are braided with carbon fibers or silicon carbide braided yarns. In a case of forming a golf club shaft by using the tubular body, it is fitted over a stainless steel pipe and filled with a polyamide resin in a mold. By the use of the tubular body, it is possible to prevent longitudinal elongation and thereby substantially eliminate change in the radial direction (for example, refer to JP-A No. 2001-115356).

Further, for a golf club shaft comprising a plurality of fiber-reinforced resin layers, a golf club shaft of ensuring the durability and improving the flexibility of the shaft has been developed by arranging hoop layers arranged on the butt side and reinforcing layers on the tip side of the main body successively with the fiber orientation direction being substantially perpendicular to the axial line of the shaft and controlling the resin content and the thickness for each of the fiber-reinforced layers (for example, refer to JP-A No. 2005-176960).

However, according to the braided tubular body having stability in the longitudinal shape described above, while elongation in the longitudinal direction is prevented, since braided yarns overlap in a complicated manner, the reinforcing fibers are in a corrugating state, the specific rigidity tends to be lowered and peeling tends to occur from the resin portion between the braided fibers. In this case, there is a high possibility of damaging the main body. Further, according to the golf shaft in which the hoop layers and the reinforcing layers are arranged successively to the outside of the main body layer, while the specific strength and the specific rigidity can be improved efficiently, when various loads, for example, bending, twisting, and crushing exert abruptly, it is difficult to withstand them and when a portion of the reinforcing fibers is damaged, rupture tends to proceed and to possibly damage the main body layer.

### SUMMARY OF THE INVENTION

The present invention has been accomplished in view of the foregoing situation and it is an object thereof to provide a tubular body of excellent durability capable of reliably protecting a main body layer even in a case where a load exerts abruptly and in a complicated manner.

For attaining the foregoing purpose, the present invention provides a tubular body comprising:

a main body layer formed by winding a fiber-reinforced prepreg including reinforcing fibers impregnated with a synthetic resin; and

a reinforcing layer wounded around the main body,

wherein the reinforcing layer includes:
an axial fiber layer including reinforcing fibers aligned in an axial direction of the tubular body;
a skew fiber layer formed of a first skew fiber layer including reinforcing fibers aligned in a first skew direction to the axial direction and a second skew fiber layer including reinforcing fibers aligned in a second skew direction intersecting with the first skew direction;
a circumferential fiber layer formed by aligning reinforcing fibers in a circumferential direction of the tubular body,

wherein the axial fiber layer, the skew fiber layer and the circumferential fiber are braided with a braiding yarn softer than the reinforcing fibers to form braided prepreg as the reinforcing layer.

In the braided prepreg, respective fiber layers are preferably laminated in a non-orthogonal state.

Further, in the braided prepreg, the braiding yarn softer than the reinforcing fibers is preferably braided to respective reinforcing fibers in a non-orthogonal direction.

Further, the braided prepreg is formed preferably by arranging the circumferential fiber layer between the first and second skew fiber layers and arranging the axial fiber layer at the outermost layer.

The reinforcing layer preferably has an outer surface from which the braiding yarn is exposed and which is polished, and the outer surface is covered with a transparent film.

Further, the braided prepreg is preferably formed by arranging the axial fiber layer between the first and second skew fiber layers and arranging the circumferential fiber layer at the outermost layer, and

a concave/convex direction of a braided pattern of the braiding yarn is directed in the axial direction.

Further, the tubular body preferably further comprises a fiber reinforced resin layer arranged between the main body layer and the reinforcing layer, the fiber reinforced resin layer being formed by impregnating a synthetic resin to reinforcing fibers of a low modulus of elasticity which is 50% or less of that of the reinforcing fibers used for the main body layer and the reinforcing layer.

According to the tubular body of the invention, since the reinforcing layer situated to the outside of the main body layer is formed by disposing reinforcing fibers in four directions, that is, the axial direction, two skew directions-crossing with each other, and the circumferential direction, and braiding them with a braiding yarn softer than the reinforcing fibers thereby integrating them, even when a composite load of bending, twisting and crushing exerts abruptly, this can be resisted at the outside of the main body layer where the effect is largest, and it is possible to form a tubular body of high strength by reliably protecting the main body layer and strengthening the reinforcing layer at the outside thereof and, in addition, even when injuries reaching the reinforcing fibers of the reinforcing layer should occur, since the reinforcing layer is integrated, the fracture and peeling of the reinforcing fibers can be prevented from prevailing and it is possible to form a tubular body of excellent durability.

In a case where the braided prepreg is formed by laminating fiber layers adjacent with each other in a non-orthogonal state, inter-layer peeling or inter-fiber peeling due to fiber orientation in the crossing direction can be prevented thereby making the strength and durability of the tubular body more excellent.

Further, in a case where the braided prepreg is braided by a braiding yarn softer than the reinforcing fibers to respective reinforcing fibers in the non-orthogonal direction, injury or fracture of the reinforcing fibers by the braiding yarn can be prevented to provide a tubular body of high strength and excellent durability.

Further in the braided prepreg, in a case of arranging the circumferential fiber layer between skew fiber layers laminated in a state where reinforcing fibers cross to each other, and arranging the axial fiber layer at the outermost layer, reinforcement can be attained efficiently to a composite load of bending, twisting and crushing to form a tubular body of high strength and excellent durability.

Further, in a case where the reinforcing layer has an outer surface from which the braiding yarn is exposed and which is polished, and the outer surface is covered with a transparent film, since the braiding yarn is visible from the outside, it is possible to form a tubular body having a decorative effect by the characteristic pattern layer of high strength and excellent in durability, as well as excellent in the decorative property for the appearance.

Further, in a case of forming the braided prepreg by disposing axial fiber layer between skew fiber layers where reinforcing layer are laminated in a direction crossing to each other and arranging the circumferential fiber layer at the outermost layer, in which the concave/convex direction of a pattern braided by the braiding yarn is in the axial direction, the concave/convex pattern can be developed finely.

Further, in a case of forming a fiber-reinforced resin layer prepared by impregnating a synthetic resin to reinforcing fibers with a low modulus of elasticity of 50% or less for the reinforcing fibers used for the main body layer and the reinforcing layer between both of the layers, since the impact and the load received by the reinforcing layer is transmitted in a moderated state to the main body layer, it can provide a tubular body of higher strength and excellent durability.

### BRIEF DESCRIPTION OF THE DRAWINGS

FIG. 1 is a cross sectional view of a tubular body according to a preferred embodiment of the invention.

FIG. 2 is an enlarged view for a portion of FIG. 1 surrounded by a circle II.

FIG. 3 is a view for the arrangement of prepregs forming the tubular body in FIG. 1.

FIG. 4 is an enlarged cross sectional view of a braided prepreg forming a reinforcing layer in FIG. 2.

FIG. 5 is a plan view of a braided prepreg forming the reinforcing layer in FIG. 2.

FIGS. 6A to 6C are explanatory views showing the step of braiding reinforcing fibers of a braided sheet in FIG. 5.

FIG. 7 is a plan view, like FIG. 5, of a braided prepreg forming a reinforcing layer according to other embodiment.

### DETAILED DESCRIPTION OF PREFERRED EMBODIMENTS

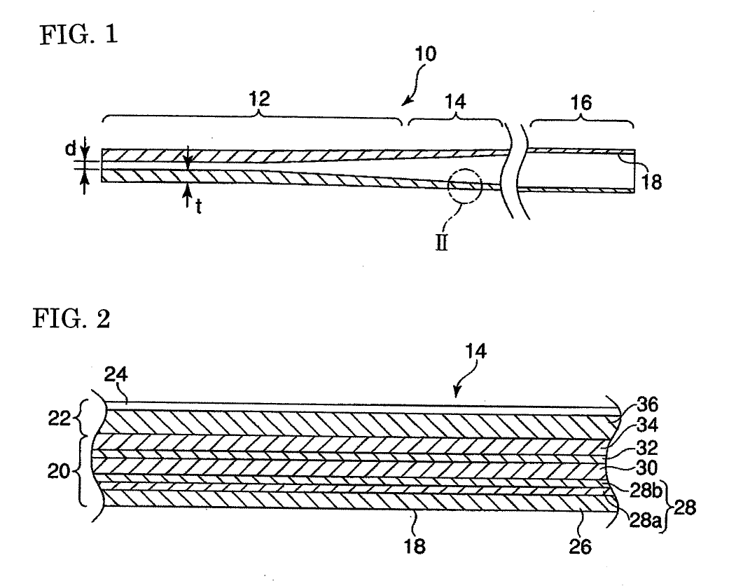

FIG. 1 shows a tubular body 10 according to a referred embodiment of the invention. In this embodiment, the tubular body is formed as a shaft of a golf club in which the strength and the rigidity have to be increased more with respect to the weight thereof. In addition, the tubular body 10 can be formed also as sport goods such as a fishing rod or a tennis racket.

The tubular body 10 of this embodiment is formed as a tapered shape toward the top end, that is, to the side of attaching a club head that hits a ball in a case of a golf club shaft. A top part 12, an intermediate part 14, and a base part 16 attached with a grip are formed from the side of the top end, and an inner hole 18 penetrating in the axial direction, that is, the longitudinal direction opens at the top end and the rear end outwardly.

In the tubular body 10, the thickness t at the top part 12 at a position where a reinforcing lug 44 to be described later is not disposed is made larger than the inner diameter d of the inner hole 18 that opens at the top end, for example, as 2.0 mm or more and from 2.4 to 3.5 mm. The thickness for the intermediate part 14 at a position where a reinforcing prepreg on the base side is not disposed is formed, for example, as 1.0 mm or more and from 1.2 to 2.0 mm. In the tubular body 10, the intermediate part 14 is formed as a most basic structure and it is preferable that various reinforcing layers are disposed at predetermined positions while ensuring the basic bending strength by a main body layer 20.

As shown in FIG. 2, the intermediate part 14 having the most basic structure of the tubular body 10 in this embodiment is formed by laminating a plurality of prepregs comprising reinforcing fibers impregnated with a synthetic resin successively from the inner side, and a film 24 covers the reinforcing layer 20 disposed to the outside of the main body layer 22. The film 24 is preferably transparent, which may be made transparent by overlaying one or plurality of transparent clear layers or colored clear layers mixed with a colored substance such as dye or pigment, or lustering particles.

In the main body layer 20, a first layer 26 on the inner circumferential side is formed by winding a circumferential prepreg formed by aligning reinforcing fibers in the circumferential direction. A second layer 28 comprising skew fiber layers 28a, 28b is formed on the outside of the first layer 26 by aligning reinforcing fibers in the direction skew to the axial line of the tubular body 10, in which respective reinforcing fibers forming the skew fiber layers 28a, 28b are oriented in the direction crossing to each other. Further, a third layer 30 as an axial fiber layer formed by aligning the reinforcing fibers in the axial direction, a fourth layer 32 formed with a circumferential fiber layer, and a fifth layer 34 formed with an axial fiber layer are disposed successively on the outside of the second layer 28. It is preferred that the main body layer 20 can ensure the basic bending strength so as to endure the large tensile force in the axial direction and the twisting direction while enabling large bending.

As to be described later, the reinforcing layer 22 formed on the main body layer 12 is formed by a composite fiber layer formed by integrally braiding four fiber layers, in which reinforcing fibers are oriented in four directions crossing to each other, by a braiding yarn as a yarn member and the braiding yarn braiding the reinforcing fibers is exposed to the outside of the reinforcing layer 22 to form a pattern as to be described later.

The tubular body 10 is formed by winding a plurality of prepregs comprising reinforcing fibers impregnated with a synthetic resin around a mandrel 8. The reinforcing mandrel for the prepreg can be formed of carbon fibers, as well as organic or inorganic fibers, for example, of glass, boron, aramide or alumina and a thermosetting synthetic resin such as epoxy, as well as a thermoplastic resin can be used also for the impregnating synthetic resin.

Impregnation amount RC of the synthetic resin for the composite fiber layer 36 preferably falls within a range from 28 wt % to 40 wt % and, particularly preferably, within a range from 30 wt % to 36 wt %. This is for preventing formation of voids or gaps between reinforcing fibers between the reinforcing fiber layers since the reinforcing fibers are oriented in plural directions. By defining the impregnation amount of the synthetic resin as described above, lowering of the strength for each of the fiber layers can be prevented to increase the strength of the tubular body 10.

Further, it is preferred to increase the impregnation amount of the synthetic resin for the reinforcing layer 22 more than that for the axial fiber layers of the third layer 30 and the fifth layer 34 and the skew fiber layer of the second layer 28 in the main body layer 20. This can prevent occurrence of voids in the reinforcing layer 22, reduce the weight of the main body layer 20 and improve the specific strength and the specific rigidity of the tubular body 10 in a well-balanced manner and also improve the durability.

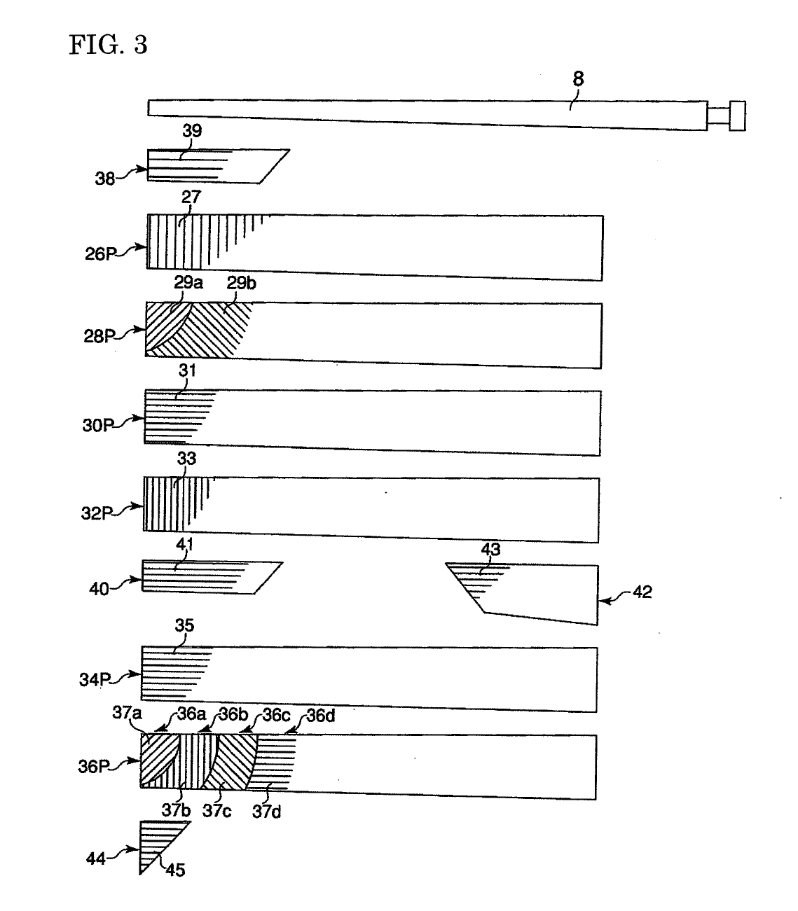

FIG. 3 shows an example for the arrangement of prepregs wound around the mandrel 8 upon forming the tubular body 10. In this embodiment, each of the prepregs to be described later is wound around the mandrel 8 in a region for about 1,200 mm length. The mandrel 8 has an outer diameter corresponding to the inner hole 18 of the tubular body 10 body forming the shaft, is formed such that the diameter at the top end is about 2.50 to 4.50 mm corresponding to the diameter d at the top end of the inner hole 18 and the diameter at the rear end of the tubular body 10 is about 14.00 to 17.00 mm, and is formed entirely as a smooth tapered shape. A skew angle of the intermediate part 14 may be changed at a portion close to the top part 12 of the tubular body 10 to change the rigidity distribution.

At the top end region of the mandrel 8, a first prepreg 38 is wound as an inner reinforcing layer for the top part 12 mainly for adjusting the rigidity balance of the top part 12. Further, a second prepreg 26P, a third prepreg 28P, a fourth prepreg 30P, a fifth prepreg 32P, and an eighth prepreg 34P for the main body layer forming the main body layer 20 are wound successively over the entire length of the shaft. At the top part 12 and the base part 16, a reinforcing sixth prepreg 40 and seventh prepreg 42 as intermediate reinforcing layers are interposed between the fifth prepreg 32P and the eighth prepreg 34P for the main body layer. The sixth prepreg 40 mainly adjusts the rigidity balance of the top part 12 and the seventh prepreg 42 reinforces a grip part disposed to the base part 16 in the axial direction or the circumferential direction, etc.

Then, a braided prepreg 36P forming a composite fiber layer 36 of the reinforcing 22 is wound around the outside of the main body layer 20, and a ninth prepreg 44 as a reinforcing lug at the outermost side is wound to the top end region on the outside. The ninth prepreg 44 is used mainly for reinforcement for attaching a not illustrated club head.

The first to ninth prepregs described above can be wound each by one layer or a plurality of layers and can be partially saved optionally. Further, positions for winding the first prepreg 38, and the sixth and seventh prepregs 40, 42 forming the inner reinforcing layer and the intermediate reinforcing layer can be adjusted to optional positions along the axial direction thereby enabling to adjusting the kick point due to improvement of the strength and increase of the rigidity for the head attaching portion.

Appropriate prepregs can be used optionally and, for example, in a case of forming a shaft of a golf club, they can be provided with properties exemplified below.

The first prepreg 38 forming the inner reinforcing layer at the top part 12 comprises, for example, reinforcing fibers 39 with a modulus of elasticity of from 20 to 50 tonf/mm² aligned in the axial direction, with the resin impregnation ratio of 25 to 33 wt %, a basis amount of fibers of 30 to 150 g/m² and a thickness of 0.03 to 0.15 mm, and it is cut into a size of 1 to 3 plies to the mandrel 8 at both axial ends. The first prepreg 38 may be backed with a glass woven fabric separately.

The second prepreg 26P as the innermost layer of the main body layer 20 is formed as a circumferential prepreg formed by circumferentially aligning reinforcing fibers 27, with a modulus of elasticity of 20 to 50 tonf/mm², a resin impregnation ratio of 25 to 40 wt %, a basis amount of fibers of 19 to 80 g/m and thickness of 0.025 to 0080 mm, and cut into a size laid to the mandrel at both axial ends each by 1 to 1.1 plies or a plurality of plies.

The third prepreg 28P disposed on the second prepreg 26P is formed as skew prepregs formed by aligning and stacking reinforcing fibers 29a and 29b with a modulus of elasticity-of-20 to 50 tonf/mm² in the skew direction crossing to each other relative to the axial direction, and the reinforcing fibers 29a and 29b of the skew prepreg 28P are oriented crossing to each other, for example, within a range of ±45° (15°) to the axial direction of the tubular body 10 for increasing the twisting strength of the tube body 10. The skew prepreg 28P is constituted so as to have a resin impregnation ratio of 25±10 wt %, a basis amount of the fibers of 55 to 150 g/m² and a thickness of 0.045 to 0.150 mm.

The fourth prepreg 30P is formed of an axial prepreg formed by aligning reinforcing fibers 31 with a modulus of elasticity of 20 to 60 tonf/mm² in the axial direction and constituted so as to have a resin impregnation ratio of 17 to 33 wt %, a basis amount of the fibers of 80 to 170 g/m² and a thickness of 0.08 to 0.170 mm. Then, it is cut into a size laid to the mandrel 8 at both axial ends each by 1 to 2 plies.

The fifth prepreg 32P is formed in the same manner as the circumferential prepreg 26P described above by aligning reinforcing fibers 33 in the circumferential direction and cut into a size laid to the mandrel 8 at both axial ends each by 1.0 to 1.1 plies. Further, by adjusting the length and the number of turns of the reinforcing prepregs 40, 42 wound around the top end region and the rear end region of the circumferential prepreg 32P, the rigidity of the tubular body 10 at the top part 12 and the base part 16 can be adjusted to a required level. In this embodiment, the reinforcing prepregs 40, 42 are formed by axially aligning reinforcing fibers 41, 43 with a modulus of elasticity of 20 to 50 tonf/mm² in the same manner as in the reinforcing prepreg 38 described above, and constituted so as to have a resin impregnation ratio of 25 to 33 wt %, a basis amount of fibers of 30 to 150 g/m² and a thickness of 0.03 to 0.150 mm.

An eighth prepreg 34P wound over the intermediate reinforcing sixth and seventh prepregs 40, 42 and the fifth prepreg 32P are formed substantially in the same manner as the axial prepreg 30P described above by aligning the reinforcing fibers 35 in the axial direction with a resin impregnation amount being defined to 30 to 35 wt % which is more than the ratio described above, and cut into a size laid to the mandrel 8 each by 1.0 to 2.0 plies. The ninth prepreg 44 as the reinforcing layer at the top end region has a constitution identical with the first prepreg 38 on the innermost layer and the intermediate sixth and seventh reinforcing prepregs 40, 42 described above and is cut so as to be wound by several turns in a state of aligning the reinforcing fibers 45 in the axial direction such that the outer diameter agrees with the inner diameter of a shaft attaching hole of the head to the top end part of the mandrel 8. Then, the braided prepreg 36P wound around with the ninth prepreg 44 is formed by braiding the skew fiber layer 36a, the circumferential fiber layer 36b, the skew fiber layer 36c, and the axial fiber layer 36d as will be described later to form the composite fiber layer 36 of the outer reinforcing layer 22 over the main body layer 20.

In a case of winding each of the prepregs around the mandrel 8, they may be wound one by one individually, or the prepregs may be previously bonded to each other optionally and may be wound. For example, the second prepreg 26P may previously be bonded with the third prepreg 28P, and the fifth prepreg 32P may be previously bonded with the fourth prepreg 30P. Further, also the reinforcing first, sixth, seventh, and ninth prepregs 28P, 40, 42, and 44 may be bonded previously to the adjacent prepregs for the main body layer and they may be wound together with the prepreg for the main body layer, or may be wound individually. After winding the prepregs around the mandrel 8 and tightening them by a tightening tape as described above, the tubular body 10 as shown in FIG. 1 is formed by a customary method, that is, by way of steps such as heating step, a cooling step, a core removing, removal of a tightening tape, polishing, coating, etc. It is preferred to form a coating layer 24 which is preferably a clear layer disposed with a transparent resin over the outer side reinforcing layer 22. In a case of forming a golf club, a club head is fitted to the top end part of the tubular body 10 and the grip is attached to the base end part to complete the same.

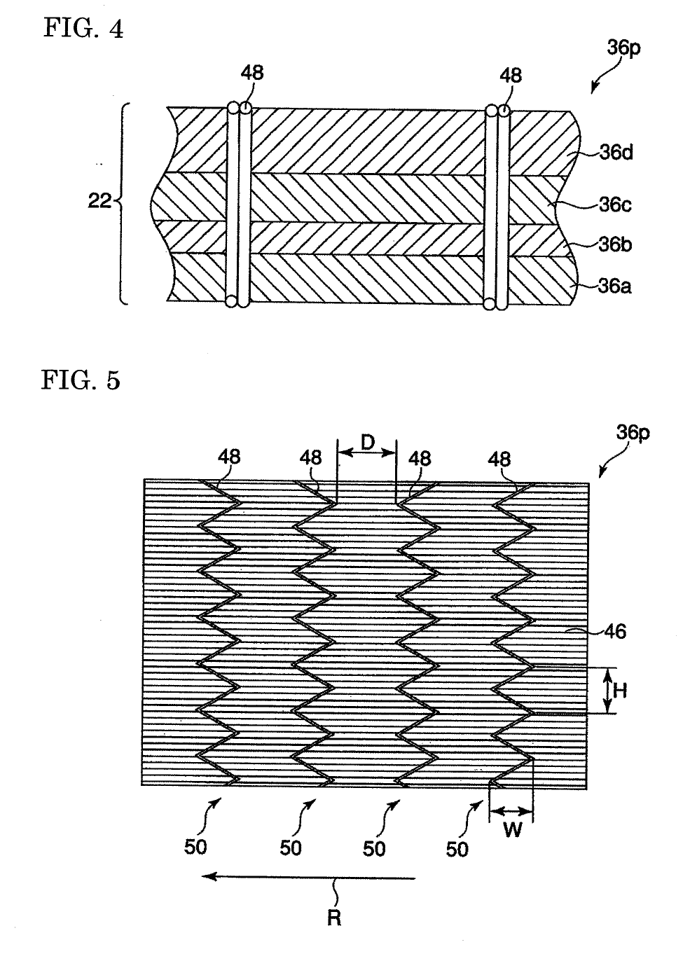

As shown in FIG. 4 and FIG. 5 specifically, the braided prepreg 36P forming the outer reinforcing layer 22 has a reinforcing material 46 formed by overlapping reinforcing fibers 37a, 37c each oriented in one direction forming skew fiber layers 36a, 36c in a state crossing to each other, interposing a circumferential fiber layer 36b comprising reinforcing fibers 37b oriented in the circumferential direction between the skew fiber layers 36a, 36c and, further, overlapping an axial fiber layer 36d having reinforcing fibers 37d oriented in the axial direction on the skew fiber layer 36c at the outermost layer. The reinforcing fibers 37a to 37d of respective fiber layers 36a to 36d oriented in the axial direction, two skew directions crossing to each other and the circumferential direction, that is, four directions in total are oriented being overlapped such that at least the reinforcing fibers 37a to 37d of fiber layers adjacent with each other are in a non-orthogonal, that is, do not cross orthogonal to each other thereby capable of preventing inter-layer peeing or inter-fiber peeling due to fiber orientation in the orthogonal direction. This can make the strength and the durability of the tubular body 10 more excellent.

Relation for the thickness of each of the fiber layers 36a to 36d can be set optionally depending on the condition of use, and the total thickness is preferably within a range of from 0.08 mm to 0.32 mm. This is because uniform alignment of the fibers is difficult when the thickness is less than 0.08 mm and the thickness changes greatly at the winding end to lower the workability when the thickness is more than 0.32 mm. Furthers the thickness for each of the skew fiber layers 36a, 36c is preferably less than that of the axial fiber layer 36b and equal with or less than that of the circumferential fiber layer 36b since the fibers are used being overlapped in the direction crossing to each other. Then, the thickness of the axial fiber layer 36a disposed to the outermost side is preferably within a range from 25% to 50% for the entire thickness of the fiber layers 36a to 36d in order to improve the specific bending rigidity.

Further, the fiber layers 36a to 36d form a braided prepreg 36P impregnated with the synthetic resin so as to provide the impregnation amount RC of the synthetic resin described above as a reinforcing member 46 having a cloth-like structure braided with a braiding yarn 48 softer than the reinforcing fibers 37b to 37d. Therefore, this prevents meandering or localization of the reinforcing fibers 37a to 37d in each of the fiber layers 36a to 36d to cause less peeling from the adjacent layers or fracture. Particularly, in a case where the braiding yarn 48 is formed softener than the reinforcing fibers 37a to 37d and the braiding yarn 48 braid the laminated respective reinforcing fibers 37a to 37d in a non-orthogonal direction, injury or fracture of the reinforcing fibers 37a to 37d by the braiding yarn 48 can be prevented to form a tubular body 10 of high strength and excellent durability.

Since the peeling between the laminated fiber layers or fracture can be prevented, the braided prepreg 36b can prevent displacement of the reinforcing fibers 37a to 37d and the braiding yarn 48 in the outer reinforcing layer 22 and even when a composite load such as bending, twisting and crushing exerts abruptly to the tubular body 10, this can be endured at the outer side of the main body layer 20 where the effect is largest to reliably protect the main body layer 20 and reinforce the outer reinforcing layer 22 to form a tubular body 10 of high strength. Further, even when an injury reaching the reinforcing fibers 37a to 37d of the reinforcing layer 22 should occur, since the reinforcing layer 22 is entirely integrated, fracture and peeling of the reinforcing fibers 37a to 37d can be prevented from prevailing to form the tubular body 10 of excellent durability. Further, it is possible to form a required appearance of the tubular body 10 exactly, and stabilize and improve the strength of the reinforcing layer 22.

Particularly, since the fiber layers 36a to 36d comprising the reinforcing fibers 37a to 37d in various directions are integrated by the braiding yarn 48, this can prevent micro-peeling between each of the fiber layers 36a to 36d and reinforcing fibers 37a to 37d, that is, occurrence of such a state that bonding force between the fibers or between the layers is lowered where inherent rigidity or sharpness can no more be provided although this is not an actually fractured state. Accordingly, a tubular body 10 causing less collapsing or spineless phenomenon and excellent in durability can be obtained.

For the braiding yarn 48 for integrally braiding the fiber layers 36a to 36d of the braided prepreg 36P, non-elastic yarns, for example, polyester yarns, nylon yarns, polyacrylic yarns or rayon yarns, or elastic yarns such as polyurethane yarns can be used. In a case of forming the braiding yarn 48 with such synthetic resins, a filament yarn such as a monofilament yarn or a multi-filament yarn is used preferably. Further, not only the braiding yarn of synthetic fibers but also natural fibers such as a cotton yarn can also be used alone or in combination with the synthetic fibers. In any of the cases, it is preferred that the braiding yarn is formed of a material softer than the reinforcing fibers 37a to 37d, that is, having a property of not injuring the reinforcing fibers or not deteriorating the effectiveness thereof.

Particularly, in a case of forming the braiding yarn 48 with a polyester yarn or a nylon yarn, since the hygroscopicity is high, impregnation property is good and adhesion with the resin M to be impregnated can be improved. Further, since the braiding yarn 48 protrude in a state of crossing the reinforcing fibers 37a to 37d, an area of contact with the peripheral resin is increased. Further, since the reinforcing fibers of the adjacent main body layer 20 are aligned in the direction crossing the direction of aligning the reinforcing fibers 37a on the nearest side, even when the direction of the exerting force is different, the braiding yarn 48 increases the bonding force of the reinforcing fibers 37a, suppressing inter-layer peeling and preventing fracture to form a stable patterned layer. Particularly, in a case where the hygroscopicity of the braided yarn 48 is high, integrity with the adjacent main body layer 20 or film layer 24 is increased.

In this embodiment, the braiding yarn 48 is made diametrically larger than the reinforcing fibers 37a to 37d, the reinforcing fibers 35 of the main body layer 20 and the reinforcing fibers 45 of the reinforcing layer. This prevents the braiding yarn 48 from locally pressing the reinforcing fibers 37a to 37d, 35, 45 to suppress lowering of the strength of the reinforcing fibers 35, 37a to 37d, 45. For example, in a case where the outer diameter of the reinforcing fibers 35, 37a to 37d, 45 is from 5 to 10 μm, it is preferred that the outer diameter of the braiding yarn 48 is from 8 to 15 mm which is larger than the former.

Particularly, as shown in FIG. 5, in this embodiment, the braiding yarn 48 forms zigzag wales 50 at a pitch H of 3 to 7 mm with a width W of 3 to 8 mm as a braiding ridge in a direction crossing each of the reinforcing fibers 37a to 37.d of the braided prepreg 36P. The wales 50 are independent of each other and extend substantially in parallel at a distance D of 0 to 10 mm. It is preferred that the braiding yarn 48 extends in a non-orthogonal direction not orthogonal to the reinforcing fibers 37a to 37d and arranged such that a load is less concentrated locally on the reinforcing fibers 37a to 37d or the braided prepreg 36P. This can prevent the reinforcing fibers 37a to 37d from being injured or fractured by the braiding yarn 48 to form a tubular body of high strength and excellent durability.

Further, since the reinforcing fibers 37a to 37d are maintained by the braiding yarn 48, the reinforcing fibers 37a to 37d less meander when they are wound around the mandrel 8 or bending, twisting or the like exerts on the tubular body 10. In a case where the distance between the wales 50 formed by the braiding yarn 48 is more than 20 mm, the reinforcing fibers 37a to 37d tend to be displaced between the wales 50.

Further, by arranging a corrugating (concave/convex) pattern formed by the braiding yarn 48 along the axial direction shown by an arrow R in FIG. 5, a zig-zag pattern along the circumferential direction is formed at a predetermined distance D and the pattern can be emphasized.

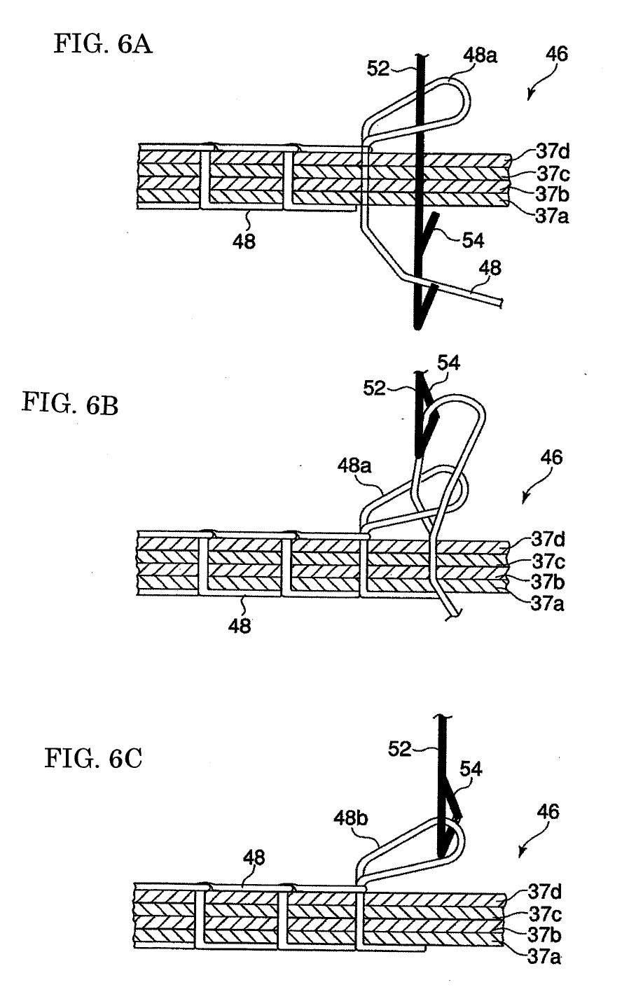

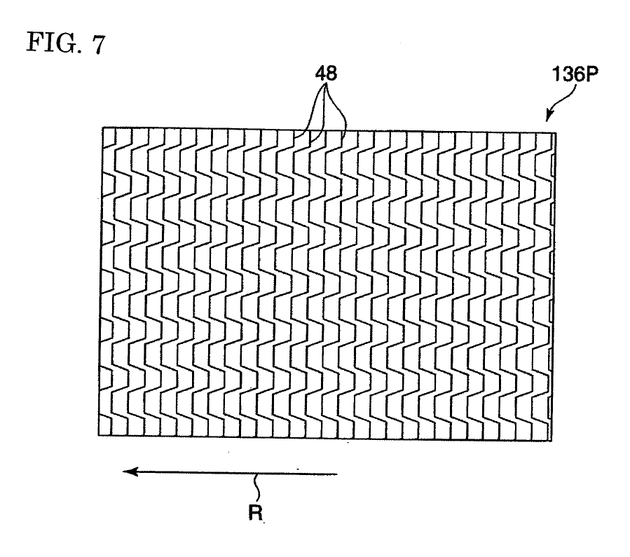

FIG. 6 schematically shows an example of procedures for forming such a braided prepreg 36P.

As shown in FIG. 6A, a needle 52 is pierced through a previously formed loop 48a from one side of a cloth-like reinforcing member 46 formed by crossing the reinforcing fibers 37a to 37d, to hook the braiding yarn 48 on the yarn feed side at the hooked needle point formed at the top end. Then, as shown in FIG. 6B, the needle 52 is pulled back to one side of the reinforcing member 46 and, while wringing the previously formed loop 48a, a new loop 48b is formed as shown in FIG. 6C. Then, the reinforcing member 46 or the needle 52 is moved and the step shown in FIG. 6A is repeated. By the opening and closure of a latch 54 disposed to the needle 52, the braiding yarn 48 can be fed to or withdrawn from the hooked needle point at a preferred position. This forms a reticulation with a mono-circular first loop formed on one side of the reinforcing member 46 and a second loop exposed linearly on the other side opposed thereto, to maintain the reinforcing fibers 37a to 37d within the reticulation. Since the braiding is conducted only by the braiding yarn 48, the reinforcing fibers 37a to 37d do not meander to stabilize the strength of the braided prepreg 36P.

The reinforcing member 46 of the braided prepreg 36P can be braided by using the latch needle 52 as described above or, alternatively, can be braided by using a bearded needle or usual knitting needle. Further, it can be stitched by circular stitches using a suitable stitching machine such as a circular stitching machine. Further, for the shape of the knitting or stitching, it can be formed into an appropriate structure conforming to the orienting direction of the reinforcing fibers 37a to 37d.

In any of the cases, after braiding the reinforcing member 46 comprising the reinforcing fibers 37a to 37d, by pressing the reinforcing member 46 being put between a pair of thin synthetic resin sheets, the braided prepreg 36P is formed as a prepreg formed by impregnating a resin to the reinforcing member 46 comprising the reinforcing fibers 37a to 37d. The synthetic resin to be impregnated to the reinforcing member 46 is preferably colorless and transparent or colored and transparent particularly for making the pattern formed with the braiding yarn 48 conspicuous.

Particularly, in a case where the reinforcing layer 22 has an outer surface from which the braiding yarn 48 is exposed and which is polished, and the outer surface is covered with the transparent film 24, a tubular body 10 having the decorative effect for the characteristic patterned layer, of high strength and excellent in the durability and also excellent in the decorative appearance can be formed.

Further, the braided prepreg 36P is not restricted to those in which the reinforcing fibers 37a to 37d are dispersed and disposed substantially uniformly over the entire surface of the cloth-like reinforcing member 46 forming the braided prepreg 36P as in the embodiment described above, but it may be also formed in an appropriate patterned shape. The wale 50 increases the strength of the impregnating resin layer in a region where the reinforcing fibers 37a to 37d are not present to increase the strength of the braided prepreg 36P.

For example, in a case of forming a woven cloth to a portion in the inner layer of the braided prepreg 36P, the appearance is improved with the pattern in combination with the woven cloth.

Further, the wales 50 may be formed not being restricted in one direction but, for example, by crossing to each other in a quilted state, or may be formed in a curved shape. By making the color of the braiding yarn 48 forming the wales 50 different from that of the reinforcing fibers 37a to 37d, the wales 50 are made conspicuous to form excellent appearance. It is not restricted to only one color but a plurality of colors can be combined on every wale 50 or in an identical wale 50.

The braided prepreg 36P forming the outer reinforcing layer 22 can form at least a portion of the main body layer 20, for example, instead of the second to fourth prepregs 26P to 30P as shown in FIG. 3 or together with such prepregs. In this case, the braided prepreg 36P is wound on the circumferential prepreg 32P. The braided prepreg 36P is preferably constituted so as to have a resin impregnation ratio of 40±15 wt %, a basis amount of the fibers of 98 to 200 g/m², and a thickness of 0.100 to 0.250 mm. It may suffice that the thickness of the braided prepreg 36P is 0.260 mm or less, and the thickness of each of the braided sheets may be 0.120 mm or less. This is because winding is facilitated by a reduced thickness and the shearing force between the sheets is moderated. Further, the resin impregnation ratio is preferably larger than that of the adjacent prepreg. The resin impregnation ratio is increased in order to impregnate the resin sufficiently to the gap between the braiding yarn to enhance inter-layer adhesion. It is preferred that the braided prepreg 36P is cut into a size laid by 1 ply on the mandrel 8 for stabilizing the circumferential outer diameter and the rigidity.

In a case of forming the main body layer 20 by using the braided prepreg 36P, it can be arranged at an appropriate position. In any case, displacement of the reinforcing fibers 37a to 37d upon deformation of the tubular body 10 can be prevented, whereby a tubular body 10 causing less inter-layer peeling, fracture or the like, improved with specific strength and specific rigidity, and having high degree of freedom can be obtained.

FIG. 7 shows a braided prepreg 136P of a modified example. In the braiding yarn 48, since the distance D along the axial direction R (refer to FIG. 5) is 0 and the concave/convex direction is along the axial direction, a trapezoidal pattern is formed along the circumferential direction.

In the embodiment described above, the reinforcing member 46 is previously formed by laminating reinforcing fibers 37a to 37d in four directions and braiding them by braiding yarn 48 and the braided prepreg 36P impregnated with the resin is formed by pressing the reinforcing member 46 being put between thin synthetic resin sheets. However, this is not restrictive but prepregs in which the respective reinforcing fibers are aligned in one direction are laminated and the prepregs may be braided by the braiding yarn 48. Then, it may be put between a pair of synthetic resin sheets to cover the braiding yarn 48 with the resin and, further, a resin may be filled in the holes formed by the needle 52. In the case of laminating such uni-direction prepreg, instead of forming all the fiber layers 36a to 36d with prepregs, only a portion thereof may be formed of the prepreg, to which a fiber layer not impregnated with the synthetic resin may be overlapped.

In a case of overlapping the reinforcing fibers 37a to 37d of the fiber layers 36a to 36d in a non-orthogonal direction, it is most preferred that the orienting direction of the reinforcing fibers in the adjacent fiber layer is at an inclination of 10° or more and 80° or less with each other, more preferably, not in crossing direction within a range from 30 to 60° and all of them cross to each other by 45° that is, four directions in all.

Then, in a case of arranging the axial fiber layer at the outermost layer 36d, it is possible to form a reinforcing layer 22 excellent both in the strength and the appearance and, in a case of arranging the circumferential fiber layer to the outermost layer 36d, the concave/convex pattern in the axial direction by the braiding yarn 48 can be developed finely particularly, along the circumferential direction.

Further, in a case of forming a fiber reinforced resin layer (not illustrated) formed by impregnating a synthetic resin to reinforcing fibers with a low modulus of elasticity at 50% or less of the reinforcing fibers for the main body layer 20 and the reinforcing layer 22 between both of the layers, since the impact and load exerting on the reinforcing layer 22 is transmitted in a moderated state to the main body layer, a tubular body 10 of higher strength and excellent durability can be formed. In this case, for the layer of the low modulus of elasticity, it is preferred to use reinforcing fibers of higher modulus of elasticity than that of the impregnating synthetic resin, with the reinforcing fibers at 1200 kg/mm² or less. Further, for the synthetic resin impregnation ratio (RC) it is preferred that the amount of resin is increased to more than that of the main body layer 20 and used in the same range as the reinforcing layer 22.

Further, it can be used suitably also to other sport goods than the shaft of the golf club and, in this case, the main body layer 20 may be of a structure used usually, for example, a lamination structure and the reinforcing layer 22 described above can be formed to the outside thereof.

For example, in a case of use for the fishing rod, the reinforcing layer 22 can be formed in the same manner as described above. On the other hand, for the main body layer 20, it is necessary to have a structure increased in the bending rigidity, light in weight even for a long rod, and not heavy upon handling. It is preferred to save the second layer 28 described above as the skew fiber layer (FIG. 2) or form it extremely thin and increase the ratio of the axial fibers by so much.

Further, in a case of use for a tennis racket, while the reinforcing layer 22 can be formed in the same manner as in the embodiment described above, it is preferred to increase the ratio of the circumferential or skew fibers for the main body layer 20 so that it can withstand a load in the compressing direction. Further, in a case of use for a ski stock, the embodiment described above regarding the shaft for the golf club can be applied.

What is claimed is:

1. A tubular body comprising:
a main body layer formed by winding a fiber-reinforced prepreg including reinforcing fibers impregnated with a synthetic resin; and
a reinforcing layer wounded around the main body,
wherein the reinforcing layer includes:
an axial fiber layer including reinforcing fibers aligned in an axial direction of the tubular body;
a skew fiber layer formed of a first skew fiber layer including reinforcing fibers aligned in a first skew direction to the axial direction and a second skew fiber layer including reinforcing fibers aligned in a second skew direction intersecting with the first skew direction;
a circumferential fiber layer formed by aligning reinforcing fibers in a circumferential direction of the tubular body,
wherein the axial fiber layer, the skew fiber layer and the circumferential fiber are braided with a braiding yarn softer than the reinforcing fibers to form braided prepreg as the reinforcing layer.

2. The tubular body according to claim 1, wherein the braided prepreg is formed by laminating the fiber layers adjacent with each other in a non-orthogonal state.

3. The tubular body according to claim 1, wherein the braided prepreg is formed so that the braiding yarn braids the reinforcing fibers in a non-orthogonal direction, respectively.

4. The tubular body according to claim 1, wherein the braided prepreg is formed by arranging the circumferential fiber layer between the first and second skew fiber layers and arranging the axial fiber layer at the outermost layer.

5. The tubular body according to claim 1, wherein the reinforcing layer includes an outer surface from which the braiding yarn is exposed and which is polished, and the outer surface is covered with a transparent film.

6. The tubular body according to claim 1, wherein
the braided prepreg is formed by arranging the axial fiber layer between the first and second skew fiber layers and arranging the circumferential fiber layer at the outermost layer, and
a concave/convex direction of a braided pattern of the braiding yarn is directed in the axial direction.

7. The tubular body according to claim 1 further comprising a fiber reinforced resin layer arranged between the main body layer and the reinforcing layer, the fiber reinforced resin layer being formed by impregnating a synthetic resin to reinforcing fibers of a low modulus of elasticity which is 50% or less of that of the reinforcing fibers used for the main body layer and the reinforcing layer.
